(19) United States
(12) Patent Application Publication
(10) Pub. No.: US 2004/0010540 A1
(43) Pub. Date: Jan. 15, 2004

(54) Method and system for streamlining data transfer between a content provider server and an output server

(76) Inventors: Anish N. Puri, Westford, MA (US); Michael J. Vigneau, Stoneham, MA (US); Leonid Winestein, Chestnut Hill, MA (US)

Correspondence Address: POLAROID CORPORATION, PATENT DEPARTMENT, 1265 MAIN STREET, WALTHAM, MA, 02451, US

(21) Appl. No.: 10/191,891

(22) Filed: Jul. 9, 2002

(51) Int. Cl. G06F 15/16

(52) U.S. Cl. 709/203

(57) ABSTRACT

A method of obtaining from a content provider server, at an output server, content and identifying data in a data structure that facilitates providing output to a remote output device is disclosed. The method comprises the steps of:

receiving, from the content provider server, a metadata file comprising the identifying data, receiving, from the content provider server, a layout file describing position of files of the content data in output to be provided by the remote output device, and,

receiving, from the content provider server, content data files referenced by the layout file.

In one embodiment, the metadata file comprises a generalized markup language file, such as an XML file and the layout file comprises a markup language file, such as an HTML file. The metadata file comprises identifying data for a content provider and identifying data for the content data and identifying data for a user of the content.

### CROSS REFERENCE TO RELATED APPLICATIONS

This application is related to the following commonly-owned patent applications, each of which is hereby incorporated by reference herein in its entirety:

U.S. patent application Ser. No. 09/870,538, filed May 30, 2001, entitled “Method and Apparatus for Printing Remote Images Using a Mobile Device and Printer”;

U.S. patent application Ser. No. 10/022,924, filed Dec. 18, 2001, entitled “Method and Apparatus for Printing Remote Images Using a Network-Enabled Printer”;

U.S. patent application Ser. No. 10/024,068, filed Dec. 18, 2001, entitled “Method and Apparatus for Providing Output from Remotely Located Digital Files Using a Mobile Device and Output Device”;

concurrently filed United States patent application Ser. No. aa/AAA,AAA, entitled “Method and Apparatus for Providing Output from Remotely Located Digital Files Using a Remote Printer” (Attorney Docket No. 8531);

concurrently filed United States patent application Ser. No. bb/BBB,BBB, entitled “System for Remotely Rendering Content for Output by a Printer” (Attorney Docket No. 8527); and

concurrently filed United States patent application Ser. No. cc/CCC,CCC, entitled “Method and System for Communicating Between a Remote Printer and a Server” (Attorney Docket No. 8532).

### BACKGROUND OF THE INVENTION

The present invention relates to services available via communication devices. More specifically, it relates to providing a permanent record, at a remote printer, of the service rendered.

Background Description

It is commonplace to purchase services via communication devices. Using a telephone it is possible to purchase airline tickets, event tickets, and an entire range of merchandise. When obtaining such services via the telephone, the user must wait to receive confirmation of the completed transaction until a permanent record is received, most likely via a postal service or a courier service.

More recently the Internet, and in particular the World Wide Web (usually referred to as “the Web”), has been increasingly used for obtaining services. The Web has also enabled the expansion of the services available. It is possible to purchase airline tickets, event tickets, and other merchandise, as well as to share digital images, to obtain maps and directions, and to receive coupons and other information via the Web. Generating a permanent record for services obtained via the Web requires issuing a print command in order to print, at a printer connected to the computer used to access the Web, a page or a document obtained from the Web. A user does not have the opportunity to print at a remote site not connected to the computer being used to access the Web. This precludes obtaining the service at one site and the permanent record at another site, as would be the case if the user wanted to share a permanent record of an image with another user at a remote site or if the user wanted to print the permanent record of a ticket at another site. Furthermore, the limitation of printing only at printers connected to the computer used to access the Web results in mobile users being required to have a printer connected to the mobile computing device.

What is needed, therefore, are improved techniques for downloading and printing digital images.

In concurrently filed application Ser. No. aa/AAA,AAA, entitled “Method and Apparatus for Providing Output from Remotely Located Digital Files Using a Remote Printer” (Attorney Docket No. 8531), techniques are disclosed for coupling a printer to a communications network (such as a Plain Old Telephone Service network or wireless voice or data networks), downloading printing information (such as a digital image) to the printer over the communications network, and using the printer to print output based on the printing information. The printer includes a network communications device, such as a modem, that enables the printer to connect directly to the communications network. The printing information may be downloaded to the printer in any of a variety of ways. For example, the printer may establish a connection to a printing server that serves the printing information. A connection between the printer and the printing server may be established, for example, by using the printer to place a telephone call to the printing server over a Plain Old Telephone Service (POTS) network. The printer may then download the printing information over the POTS network and print the image specified by the printing information.

It should be appreciated that the printing information may have previously been generated in any of a variety of ways, as described above. For example, as described in more detail in the above-referenced application Ser. No. 09/870,538, filed May 30, 2001, entitled “Method and Apparatus for Printing Remote Images Using a Mobile Device and Printer,” the user may have previously conducted a transaction with a transaction server. The transaction may, for example, be a transaction for requesting or purchasing items such as tickets, maps, brochures, coupons, photographs, menus, or schedules or audiovisual information. Upon completion of the transaction, the transaction server may communicate with the output server described above to produce the printing information to be printed (such as a digital image of the purchased item). The printing information may be transmitted to the printer by, for example, the output server.

Most of the interaction between a client and a server takes place via a browser where the browser obtains the information on how to display the text and graphics files from HTML (HyperText Mark-up Language) files. The communication between servers can take place via various other protocols but complex files will typically be in formats such as PDF, Postcript or ASII text. In most cases, data has to be converted into the format used. This conversion adds to the complexity of the process of preparing the data for printing. If besides transferring files, it is necessary to transfer other information such as identifying data for the user and identifying data for all other destinations for the objects to be shared, the transferred files could be even more complicated and means for separating the identifying data and the output to be rendered have to be provided.

There is a need for techniques that facilitate the providing of content and identifying data from a content server to a printing server, where the content will be provided to a remote printer to be rendered as output.

It is therefore an object of this invention to enable the converting of content and identifying data, originating at a content provider server, to a structure that facilitates providing output to a remote output device from an output server.

It is a further object of this invention to enable an output server to obtain, from a content provider server, content and identifying data in a structure that facilitates providing output to a remote output device.

### SUMMARY OF THE INVENTION

The objects set forth above as well as further and other objects and advantages of the present invention are achieved by the embodiments of the invention described hereinbelow.

A method of obtaining from a content provider server, at an output server, content and identifying data in a data structure that facilitates providing output to a remote output device is disclosed. The method comprises the steps of:

receiving, from the content provider server, a metadata file comprising the identifying data,

receiving, from the content provider server, a layout file describing position of files of the content data in output to be provided by the remote output device, and,

receiving, from the content provider server, content data files referenced by the layout file.

In one embodiment, the metadata file comprises a generalized markup language file, such as an XML file and the layout file comprises a markup language file, such as an HTML file. The metadata file comprises identifying data for a content provider and identifying data for the content data and identifying data for a user of the content.

Markup languages, such as HTML, describe how to arrange text, images, and several other features on a displayed page. Because markup languages describe the layout on a page, they perform well as layout description languages. Other languages, mostly commercially available and proprietary such as PCL5 and Postscript, distinguished here from markup languages, are available for page layout. However, some markup languages, such as HTML, are in the public domain and have widespread use.

While HTML provides an analogy to a publishing language, it is not flexible (and therefore not fast) enough to be used alone for the task described above. Recently introduced metalanguages, languages to describe languages, can provide, when used along with HTML, the desired functionality. (See, for example, “XML in 10 points”, http://www.w3.org/XML/1999/XML-in-10-points.) The Extensible Markup Language (XML) is designed to make it easy to interchange structured documents over the Internet. Style sheet description languages, languages such as CSS and XSL that provide the ability to describe presentation details, have been recently adopted by the World Wide Web Consortium (W3C). The style sheet descriptions improve the flexibility of HTML. (See, for example, Eric A. Meyer, “Cascading Style Sheets—The Definite Guide”, O'Reilly and Associates, Sebastopol, Calif., 2000, ISBN 1-56592-622-6).

In another embodiment of this invention, the layout file comprises a markup language file, such as an HTML file, and a style language file, such as linked cascading style sheets (CSS). In a further embodiment of this invention, the layout file comprises an extended markup language file, such as an XML file, and a style language file, such as cascading style sheets (CSS).

Thus, the data structure of this invention provides content provider identification data, content type, file names, time information, output size information, number of copies, user identifying data and identifying data for other users who will receive copies of the output (sometimes labeled as “User's friends”) in the metadata file and layout in the layout file. All the necessary information to provide the output is contained in the data structure and described in public domain, standard languages such as XML, CSS and HTML that have widespread use.

Computer readable code embodied in a computer usable medium, such as a memory and/or a carrier wave, implements the method described above at the content provider server and at the output server.

One embodiment described in detail comprises print as output. However, it should be apparent that the output may be any of the types of information that the output device may receive and output. The output device may, for example, be a CD drive (such as a CD-ROM, CD-R, or CD-RW drive), DVD player, or MP3 player that includes a network communications device and performs the functions of an output device.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a graphical representation of a printer-server system embodying this invention;

FIG. 2 is a graphical representation and flowchart of a content provider server-output server system embodying this invention;

FIG. 3 is a graphical representation of an embodiment of a data structure according to this invention;

FIG. 4 is a graphical representation of possible orientations and physical dimensions of a document as output in an embodiment of this invention;

FIG. 5 is a pictorial representation of a coupon printed as output in an embodiment of this invention;

FIG. 6 represents a pictorial representation of the layout of a coupon printed as output in an embodiment of this invention;

FIG. 7 is a pictorial representation of a directions printed as output in an embodiment of this invention; and,

FIGS. 8a, 8b, and 8c depict content files utilized in FIG. 7.

### DETAILED DESCRIPTION OF THE PREFERRED EMBODIMENTS

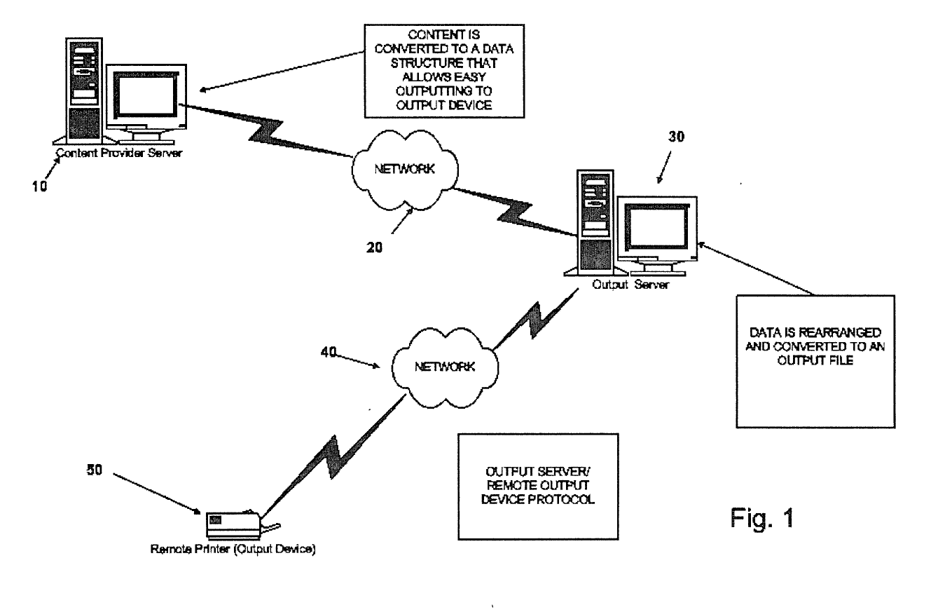

Data from a content provider server 10, as shown in FIG. 1, is transmitted to output server 30 via a network 20. Such a system is disclosed in concurrently filed U.S. patent application Ser. No. aa/AAA,AAA, entitled “Method and Apparatus for Providing Output from Remotely Located Digital Files Using a Remote Printer”, (Attorney Docket No. 8531). A method for converting content and identifying data, originating at the content provider server 10, to a data structure that facilitates providing output to a remote output device 50 from the output server 30 is disclosed herein below.

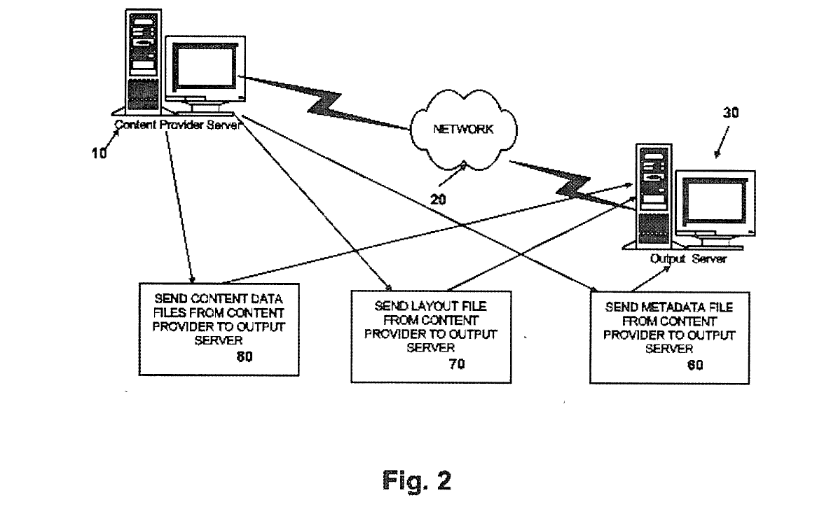

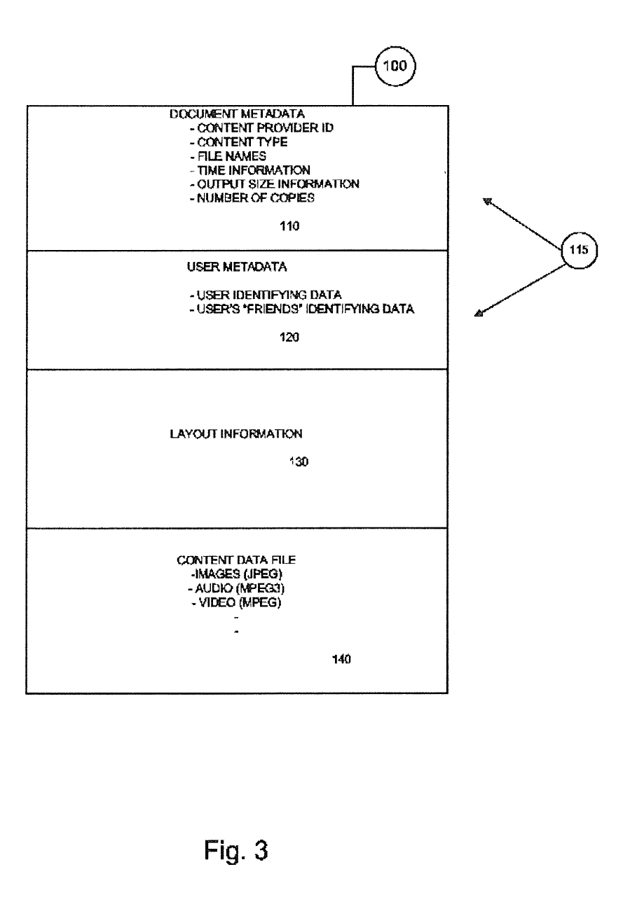

Referring to FIG. 2, an archive 100 (depicted schematically in FIG. 3), a collection of files, is sent from the content provider server 10 to the output server 30 via the network 20. The files provide the output server 30 with content and identifying data for output to be rendered by the remote output device 50. The files sent include a metadata file 115 (step 60, FIG. 2) comprising the identifying data for a content provider and for the content data 110 and identifying data for a user of the content 120 (a metadata file contains the definition or description of data), a layout file describing the position of content data files in the rendered content 130 (step 70, FIG. 2), and the content data files 140 (step 80, FIG. 2). The metadata file 115 is, in one embodiment, a generalized markup language file generated in a language, such as XML (Extensible Markup Language) or SGML (Standard Generalized Markup Language), that can be used to describe how to describe a collection of data. The layout file 130 is, in one embodiment, a markup language file. Markup languages, such as HTML, describe how to arrange text, images, and several other features on a displayed page. Because markup languages describe the layout on a page, they perform well as layout description languages. Since the rendering of objects is static, many of the features of a markup language, designed to dynamically connect pages, can be omitted. Other languages, mostly commercially available and proprietary, are available for page layout. However, some mark up languages, such as HTML, are in the public domain and have widespread use.

In another embodiment of this invention, the layout file 130 comprises a markup language file, such as an HTML file, and a style language file, such as linked cascading style sheets (CSS). In a further embodiment of this invention, the layout file 130 comprises an extended markup language file, such as an XML file, and a style language file, such as cascading style sheets (CSS). Both XML and CSS are in the public domain.

The content data files 140 are of different format dependent on the content. In one embodiment, image files are JPEG files, graphic files are GIF files, audio files are MPEG3 files and video files are MPEG files. It should be apparent that any standard format for the type of content can be used.

The archive 100 defines a structure, depicted in FIG. 3, that facilitates providing output from the output server 30 to a remote output device 50. The metadata file 115 includes document metadata 110 and user metadata 120. Document metadata 110 includes content provider identification data, content type, file names, time information, output size information, and number of copies. User metadata 120 includes user identifying data and identifying data for other users (sometimes labeled as “User's friends”) who will receive copies of the output. The layout file 130 includes the layout information, the position of the content files in the output, for the output. The content data files 140 include the details of the content in files of the appropriate format, such as and JPEG (Joint Photographic Expert Group format) or GIF (graphics Interchange Format) files for images, MPEG3 (Moving Pictures Expert Group format) files for audio, and MPEG for video.

Once received at the output server 30, the data is processed, rearranged and converted into a form suitable for output. One embodiment of a method for rearranging and converting the data in the archive 100 into a form suitable for printing (output) is described in the above-referenced U.S. patent application Ser. No. bb/BBB,BBB (Attorney Docket No. 8527). It should be apparent that the output server 30 can, in an embodiment, comprise several servers or a server, a firewall, and several other servers. It should also be apparent that content provider server 10 can, in an embodiment, comprise several servers or a server, a firewall, several other servers, a voice portal or be part of a system to provide a service. Means for sending and receiving data, such as protocols and techniques, between two servers are known in the art. Some details of the interface between the content provider server 10 and the output server 30 for a detailed embodiment of this invention are given herein below.

In an embodiment of the present invention, techniques are provided for enabling content for a document to be provided, from content server 10, to the output server 30, where it is converted into a form suitable for printing at a remote printer. The content can result from the purchase of a ticket (where the ticket can be an event ticket or a airline, train or bus ticket), the obtaining of a coupon, the obtaining of maps for a specific region, or the obtaining of specific information such as restaurant reviews, menus, short reports.

The interface between Content Provider Server 10 and the output server 30 is summarized as follows:

1. The ftp (File Transfer Protocol) protocol will be used for transfer of typical content that does not require secure mode of transmission (eg: maps, directions, . . . ). In the case of secure content transmission (movie tickets, event tickets, . . . ), the content provider can implement one of several options, for example: Secure CoPy (SCP) or one of its freeware implementations, transfer of content over SSL, transfer over Secure Shell (SSH) or one of other available option.

2. Content Providers will push formatted content selected by the user to a server (for secure and non-secure content) located outside a firewall. Servers on the other side of the firewall will monitor the servers located outside the firewall and “pull” the newly arrived content into the servers on the other side of the firewall for routing to the remote output devices (printers) 50. (A similar mechanism will be used if the Content Provider or requests the output servers 30 to “pull” the formatted content directly from the Content Provider servers 10.)

The formatted content for every print request from content providers will be an archive consisting of a Metadata file 115, Layout file 130 and Images 140. The Metadata file 115 will be implemented in XML, and the Layout file 130 will be, in one embodiment, implemented as HTML. In another embodiment of this invention, the layout file 130 will be implemented using a markup language file, such as HTML, and a style language file, such as linked cascading style sheets (CSS). In a further embodiment of this invention, the layout file 130 will be implemented using an extended markup language, such as XML, and a style language, such as cascading style sheets (CSS). Every print request from the content provider server 10 will transmit the following: Metadata file 115 (XML file), Layout file 130 (HTML file) and Images 140. The XML file 115 will contain information such as the user ID, the type of content, number of copies, etc. The HTML file will contain the layout of the selected content formatted according to predetermined guidelines.

The Document Metadata 110 will be first section in the XML file 115. It will contain the following elements:

a) Content Provider ID.

b) Voice Portal ID.

c) Incoming Document Type Code

HTMLMovieTicket—1 for Movie Tickets

HTMLCoupon—2 for Coupons

HTMLMap—3 for Maps,

HTMLDirections—4 for Directions

HTMLPhoto—5 for Photographs

HTMLEmail—6 for Email

HTMLMenu—7 for Restaurant Menus

d) Name of the XML file,

e) Name of the HTML file,

f) Time stamp of the request from the user,

g) Time stamp of transmission from content provider,

h) Time until when the content is valid for printing,

i) Number of “output pages” in the HTML file (e.g., multiple pages for an email),

j) Number of copies to be printed.

The User Metadata 120 will be the second section in the XML file 115. It will contain the following elements:

a) Identification Number (PIN) of the user to whom the content is to be routed

b) Identification Numbers (PIN) of user's friends who will receive copies of the content.

A sample XML file is given below.

<?xml version=“1.0” standalone=“yes”?>
<xml_content provider_lifestyle01 >
<!- -Required data elements are listed below- - >
<doc_metadata>

<cp_id>aol</cp_id>
<doc_type>1</doc_type>
<xml_filename>XML_aol_lifestyle01_09042001-1409-

42.xml</xml_filename>

<lshtml_filename>HTML_aol_lifestyle01_09042001-

1409-42.htm</lshtml_filename>

<timestamp_request>Sep 4, 2001 14:07:39 PM

GMT+05:30</timestamp_request>

<timestamp_transmission>Sep 4, 2001 14:09:42 PM

GMT+05:30</timestamp_transmission>

<time_validuntil>Sep 6, 2001 14:09:42 PM

GMT+05:30</time_validuntil>

<no_pages>1</no_pages>
<no_copies>1</no_copies>

</doc_metadata>
<user_metadata>

<user_pin>lifestyle01</user_pin>
<!- -Optional data elements to be added based on

request from user- - >

<user_friend1_pin>lifestyle04</user_friend1_pin>
<user_friend2_pin>lifestyle06</user_friend2_pin>

</user_metadata>

</xml_contentprovider_lifestyle01>

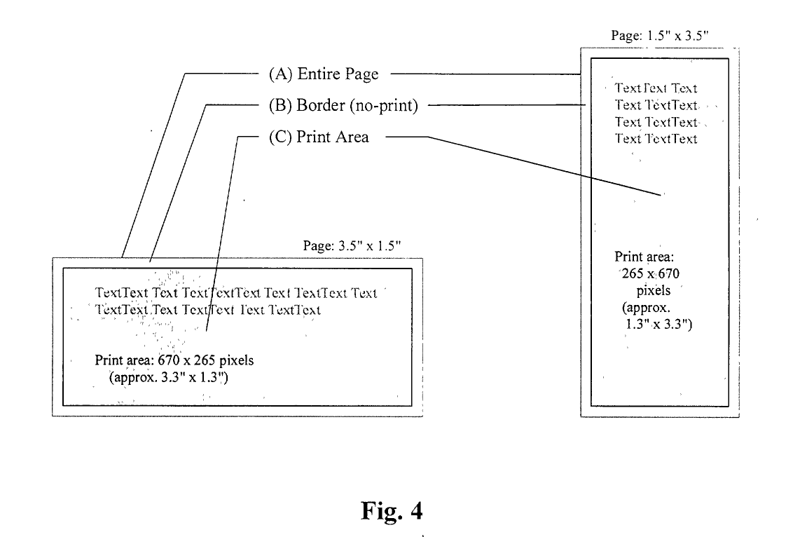

FIG. 4 depicts possible orientations and physical dimensions of a document as output in one embodiment of this invention. In this example, printers use one of two page orientations, Horizontal or Vertical. Every printer has a fixed pixel size that is used to represent the print area. The goal of the Layout file is to place the content elements in the correct positions within this print area.

Layout Utilizing HTML

In one embodiment, the Layout file 130 uses HTML as the formatting language. Since the rendering of objects is static, many of the features of a markup language, designed to dynamically connect pages, can be omitted in order to create print-optimized content.

The use of HTML makes layout of a Lifestyle page similar to the layout of a Web page. However, since the output is static, certain restrictions can be applied, namely:

(a) Frames are not used.

(b) Scripting languages (e.g., Java Script, VBScript etc.) are not used.

(c) Embedded Java applets, ActiveX controls or third-party controls (e.g., ShockWave) are not used.

(d) Animated GIF files are not used.

(e) Forms and their associated tags (such as<INPUT>and <SELECT>) are not used.

The positioning of the content elements within the print area is accomplished using <TABLE>elements with fixed-size table cells to partition the print area into suitable segments.

Each of these segments can be further sub-divided by this method (child tables embedded in the table cells of other tables) to achieve the precise content layout. This method allows for complete control of the layout of the print, down to the single pixel.

Once the printable area has been suitably segmented, each segment is populated with HTML content including:

(a) Text (<P>elements)

(b) Graphics (<IMG>elements)

(c) Photos (<IMG>elements)

(d) Nested tables (for further segmentation)

Every Layout file must have at least one table, sized to the pixel dimensions of the print area.

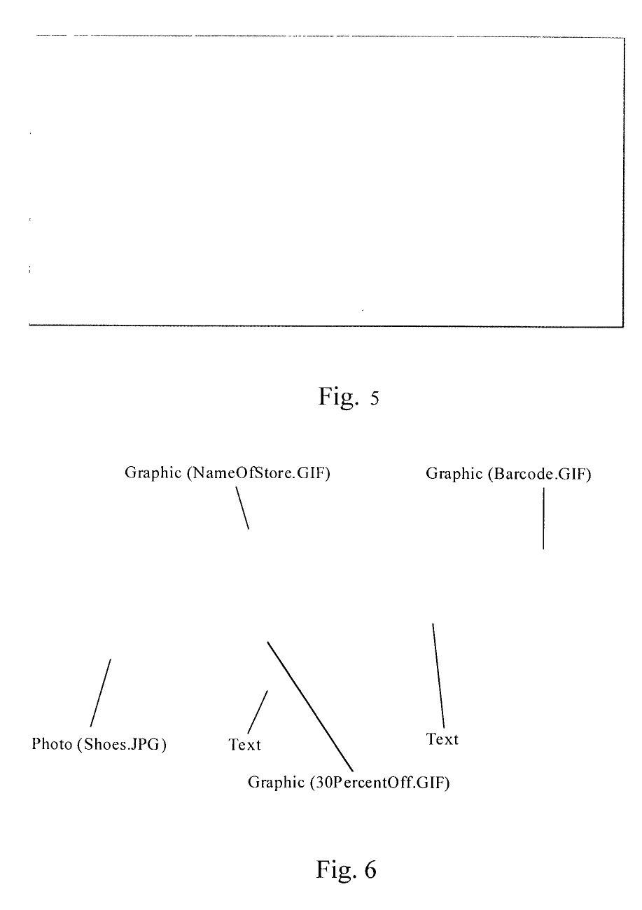

FIG. 5 depicts a sample coupon defined by the content and to be printed as output. This coupon uses Horizontal layout. It contains six elements, which are arranged as shown in FIG. 6.

This layout is achieved with four nested tables. The tables look like this:

TABLE #1
Size: 670 × 265 pixels
One row, two columns

| | |
|---|---|
| Col 1: Table #2 | Col 2: Barcode.GIF |

TABLE #2
Size: 588 × 265 pixels
Two rows, one column
Row 1: NameOfStore.GIF
Row 2: Table #3

TABLE #3
Size: 588 × 194 pixels
One row, three columns

| | | |
|---|---|---|
| Col 1: | Col 2: | Col 3: |
| Shoes.JPG | Table #4 | TEXT |

TABLE #4
Size: 180 × 194 pixels
Two rows, one column
Row 1: 30 PercentOff.GIF
Row 2: TEXT

Layout Using HTML and CSS

While HTML was designed to describe the structure of a page, in order to describe presentational details, additional tags have been added. The proliferation of tags can be cumbersome and can produce a lengthy HTML file. Style sheets provide a possible remedy. Style sheets describe how a page is presented. The use of style sheets allows a number of presentational tags to be replaced by a single specification of style. Of the several style sheet languages available, Cascading Style Sheets (CSS) is supported by browsers and has been adopted by the World Wide Web Consortium (W3C). Since CSS is easy to link to HTML, in another embodiment, the layout file 130 (the description of the position of elements of content data in output to be provided by a remote output device) uses style sheets (CSS) linked to HTML for the formatting language. The restrictions on HTML imposed above could still be imposed.

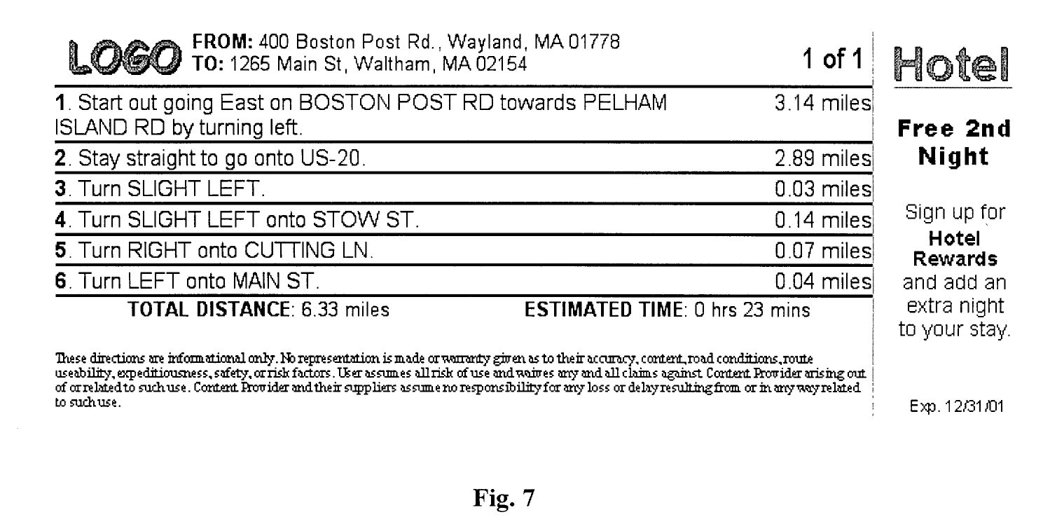

FIG. 7 is a pictorial representation of directions printed as output where the description of the position of elements of content data in the output is given by the file below, which contains style sheets (CSS) linked to HTML.

<HTML>
<HEAD>
<TITLE>Driving Directions</TITLE>
<META http-equiv=“Content-Type” content=“text/html;
charset=iso-8859-1”>
<STYLE type=“text/css”>

.page_background (background-color:#FFFFFF; width: 670px;

height:265px; z-index:0; overflow:hidden}

.region {z-index:1; position:absolute}
.font01 {font:normal 13px “Arial”}
.font02 {font:bold 20px “Arial Narrow”}
.font03 {font:normal 15px “Arial”}
.font04 {font:normal 9px “Small Fonts”}

</STYLE>
</HEAD>
<BODY bgcolor=“#330033” text=“#000000” style=“margin:0px”>
<DIV class=“page_background”>
<DIV class=“region” style=“top:0px; left:0px; width:95px; height:36px”>

<IMG src=“Logo.GIF” width=“95” height=“36”>

</DIV>
<DIV class=“region” style=“top:0px; left:95px; width:400px;
height:36px”>

<SPAN class=“font01”> <B>FROM: </B>400 Boston Post Rd.,
Wayland, MA

01778<br>

<B>TO: </B>1265 Main St, Waltham, MA 02154
</SPAN>

</DIV>
<DIV class=“region” style=“top:0px; left:495px; width:60px;
height:36px”>

<DIV style=“text-align: right”>
<SPAN class=“font02” style=“line-height:34px”> <B>1 of
1</B> </SPAN>
</DIV>

</DIV>
<DIV class=“region” style=“top:36px; left:0px; width:560px;
height:183px”>
<TABLE border=0 cellpadding=0 cellspacing=0 width=560>
<TR>

<td colspan=2 valign=center> <IMG src=“HLine.GIF” width=“560”

height=“4”> </td>
</TR>
<TR>

<td valign=top>
<SPAN class=“font03”>

<B>1</B>. Start out going East on BOSTON
POST RD towards PELHAM

ISLAND RD by turning left.

</SPAN>
</td>
<td valign=top align=right width=130>
<SPAN class=“font03”>

3.14 miles

</SPAN>
</td>

</TR>
<TR>

<td colspan=2 valign=center> <IMG src=“HLine.GIF” width=“560”

height=“4”> </td>
</TR>
<TR>

<td valign=top>
<SPAN class=“font03”>

<B>2</B>. Stay straight to go onto US-20.

</SPAN>
</td>
<td valign=top align=right width=130>
<SPAN class=“font03”>

2.89 miles

</SPAN>
</td>

</TR>
<TR>

<td colspan=2 valign=center> <IMG src=“HLine.GIF” width=“560”

height=“4”> </Ld>
</TR>
<TR>

<td valign=top>
<SPAN class=“font03”>

<B>3</B>. Turn SLIGHT LEFT.

</SPAN>
</td>
<td valign=top align=right width=130>
<SPAN class=“font03”>

0.03 miles

</SPAN>
</td>

</TR>
<TR>

<td colspan=2 valign=center> <IMG src=“HLine.GIF” width=“560”

height=“4”> </td>
</TR>
<TR>

<td valign=top>
<SPAN class=“font03”>

<B>4</B>. Turn SLIGHT LEFT onto STOW ST.

</SPAN>
</td>
<td valign=top align=right width=130>
<SPAN class=“font03”>

0.14 miles

</SPAN>
</td>

</TR>
<TR>

<td colspan=2 valign=center> <IMG src=“HLine.GIF” width=“560”

height=“4”> </td>
</TR>
<TR>

<td valign=top>
<SPAN class=“font03”>

<B>5</B>. Turn RIGHT onto CUTTING LN.

</SPAN>
</td>
<td valign=top align=right width=130>
<SPAN class=“font03”>

0.07 miles

</SPAN>
</td>

</TR>
<TR>

<td colspan=2 valign=center> <IMG src=“HLine.GIF” width=“560”

height=“4”> </td>
</TR>
<TR>

<td valign=top>
<SPAN class=font03”>

<B>6</B>. Turn LEFT onto MAIN ST.

</SPAN>
</td>
<td valign=top align=right width=130>
<SPAN class=“font03”>

0.04 miles

</SPAN>
</td>

</TR>
<TR>

<td colspan=2 valign=center> <IMG src=“HLine.GIF” width=“560”

height=“4”> </td>
</TR>
<TR>

<td colspan=“2”>
<table cellpadding=0 cellspacing=0 border=0 align=right
WIDTH=“100%”>

<TR>

<td WIDTH=“50%” ALIGN=“center”>

<SPAN class=“font01”>
<B>TOTAL DISTANCE</b>: 6.33 miles
</SPAN>

</td>
<TD ALIGN=“center” WIDTH=“50%”>

<SPAN class=“font01”>
<B>ESTIMATED TIME</b>: 0 hrs 23 mins
</SPAN>

</td>

</TR>

</table>
</td>

</TR>
</TABLE>
</DIV>
<DIV class=“region” style=“top:219px; left:0px; width:560px;
height:46px”>

<SPAN class=“font04”>

These directions are informational only. No representation is made or
warranty given as to
their accuracy, content, road conditions, route useability,
expeditiousness, safety, or risk factors.
User assumes all risk of use and waives any and all claims against
Content Provider arising
out of or related to such use. Content Provider and their suppliers
assume no responsibility
for any loss or delay resulting from or in any way related to such use.

</SPAN>

</DIV>
<DIV class=“region” style=“top:0px; left:560px; width:110px;
height:265px”>

<IMG src=“Ad.GIF” width=“110” height=“265”>

</DIV>
</DIV>
</BODY>
</HTML>

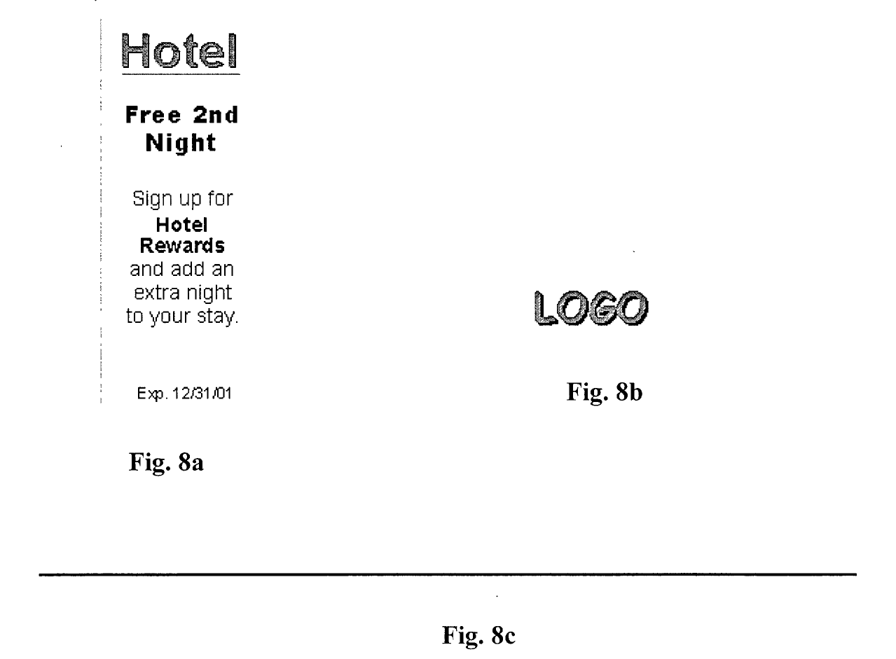

FIG. 7 also includes three content files, Ad.GIF, and LOGO.GIF, Hline.GIF, which are shown separately in FIGS. 8a, 8b, 8c.

Layout Description Using XML and CSS

Although it is not supported by many browsers, it is possible to introduce style sheets in XML utilizing CSS (See, for example, “Displaying XML with CSS”, http://www.w3schools.com/xml/xml_display.asp). Similarly, other style sheet languages (such as XSL) could be used to introduce style sheets into XML. Thus, in a further embodiment, the layout file 130 (the description of the position of elements of content data in output to be provided by a remote output device) uses style sheets (CSS) and XML for the formatting language.

Server Implementations

The methods of this invention can be implemented by a content provider server system and an output server system comprising means for implementing the methods described above. At least one processor and supporting memory at the content provider server and, similarly, at least one processor and supporting memory at the output server can be used to implement the methods of this invention. Processors can be dedicated processors, or general purpose processors and supporting memory could be any computer readable memory.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Although the above description refers to a specific embodiment, it should be apparent that other embodiments are within the scope of the invention. For example, the output server 30 can be a more than one server, or it can be comprised of several servers on one side of a firewall and at least one server on the other side of the firewall. Other similar modifications are within the scope of the art. Network 20 can be a TCP/IP network, any network that enables markup languages or any network that enables the transmission of metadata and layout files.

While the embodiment described in detail comprises print as output, it should be apparent that the output may be any of the types of information that the output device may receive and output. The output device may, for example, be a CD drive (such as CD-R, or CD-RW drive), DVD recorder, or MP3 player that includes a network communications device and performs the other functions of an output device.

Each computer program within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable (computer usable) media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method of obtaining from a content provider server, at an output server, content and identifying data in a data structure that facilitates providing output to a remote output device, said method comprising the steps of:
receiving, from the content provider server, a metadata file comprising said identifying data;
receiving, from the content provider server, a layout file describing position of files of said content data in output to be provided by said remote output device; and,
receiving, from the content provider server, content data files referenced by said layout file.

2. The method of claim 1 wherein said metadata file comprises a generalized markup language file.

3. The method of claim 1 wherein the layout file comprises a markup language file.

4. The method of claim 1 wherein the layout file comprises a markup language file and style sheets.

5. The method of claim 4 wherein the style sheets are implemented using CSS.

6. The method of claim 1 wherein the layout file comprises a generalized markup language file and style sheets.

7. The method of claim 6 wherein the generalized markup language is XML and the style sheets are implemented using CSS.

8. The method of claim 1 wherein said metadata file comprises identifying data for a content provider and for said content data and identifying data for a user of said content.

9. A method of converting content and identifying data, originating at a content provider server, to a data structure that facilitates providing output to a remote output device from an output server, said method comprising the steps of:
providing, to the output server, a metadata file comprising said identifying data;
providing, to the output server, a layout file describing position of files of said content data in output to be provided by said remote output device; and,
providing, to the output server, content data files referenced by said layout file.

10. The method of claim 9 wherein said metadata file comprises a generalized markup language file.

11. The method of claim 9 wherein the layout file comprises a markup language file.

12. The method of claim 9 wherein the layout file comprises a markup language file and style sheets.

13. The method of claim 9 wherein the layout file comprises a generalized markup language file and style sheets.

14. The method of claim 9 wherein said metadata file comprises identifying data for a content provider and identifying data for said content data and identifying data for a user of said content.

15. A computer program product comprising:
a computer usable medium having computer readable code embodied therein for obtaining from a content provider server, at an output server, content and identifying data in a data structure that facilitates providing output to a remote output device, said code causing a computer system to:
receive, from the content provider server, a metadata file comprising said identifying data;
receive, from the content provider server, a layout file describing position of files of said content data in output to be provided by said remote output device; and,
receive, from the content provider server, content data files referenced by said layout file.

16. The computer program product of claim 15 wherein said metadata file comprises a generalized markup language file.

17. The computer program product of claim 15 wherein said layout file comprises a markup language file.

18. The computer program product of claim 15 wherein the layout file comprises a markup language file and style sheets.

19. The computer program product of claim 15 wherein the layout file comprises a generalized markup language file and style sheets.

20. The computer program product of claim 15 wherein said metadata file comprises identifying data for a content provider and for said content data and identifying data for a user of said content.

21. A computer program product comprising:
a computer usable medium having computer readable code embodied therein for converting content and identifying data originating at a content provider server, to a data structure that facilitates providing output to a remote output device from an output server, said code causing a computer system to:
provide, to said output server, a metadata file comprising said identifying data;
provide, to said output server, a layout file describing position of files of said content data in output to be provided by said remote output device; and,
provide, to said output server, content data files referenced by said layout file.

22. The computer program product of claim 21 wherein said metadata file comprises a generalized markup language file.

23. The computer program product of claim 21 wherein said layout file comprises a markup language file.

24. The computer program product of claim 21 wherein the layout file comprises a markup language file and style sheets.

25. The computer program product of claim 21 wherein the layout file comprises a generalized markup language file and style sheets.

26. The computer program product of claim 21 wherein said metadata file comprises identifying data for a content provider and for said content data and identifying data for a user of said content

27. A memory for storing data for access by a process executed by a processor, said memory comprising:
a structure that allows obtaining from a content provider server, at an output server, content and identifying data in a data structure that facilitates providing output to a remote output device, said structure comprising:
a metadata file comprising said identifying data;
a layout file describing position of files of said content data in output to be provided by said remote output device; and,
content data files referenced by said layout file.

28. The memory of claim 27 wherein said metadata file comprises a generalized markup language file.

29. The memory of claim 27 wherein said layout file comprises a markup language file.

30. The memory of claim 27 wherein the layout file comprises a markup language file and style sheets.

31. The memory of claim 27 wherein the layout file comprises a generalized markup language file and style sheets.

32. The memory of claim 27 wherein said metadata file comprises identifying data for a content provider and for said content data and identifying data for a user of said content.

33. An output server obtaining from a content provider server content and identifying data in a data structure that facilitates providing output to a remote output device, said server comprising
at least one processor;
at least one computer readable memory, said at least one computer readable memory having computer instructions embodied therein, said instructions comprising:
means for receiving, from the content provider server, a metadata file comprising said identifying data;
means for receiving, from the content provider server, a layout file describing position of files of said content data in output to be provided by said remote output device; and,
means for receiving, from the content provider server, content data files referenced by said layout file.

34. The server of claim 33 wherein said metadata file comprises a generalized markup language file.

35. The server of claim 33 wherein said layout file comprises a markup language file.

36. The server of claim 33 wherein said layout file comprises a markup language file and style sheets.

37. The server of claim 33 wherein said layout file comprises a generalized markup language file and style sheets.

38. The server of claim 33 wherein said metadata file comprises identifying data for a content provider and for said content data and identifying data for a user of said content.

39. A method for obtaining, at an output server, a description of position of elements of content data in output to be provided by a remote output device, said elements including text, graphics, images, and nested tables, said method comprising the steps of:
receiving a markup language file describing the position of elements of content data in output to be provided by a remote output device;
retrieving and interpreting the position of elements of content data.

40. The method of claim 39 wherein said markup language file is an HTML file.

41. A method for obtaining, at an output server, a description of position of elements of content data in output to be provided by a remote output device, said elements including text, graphics, images, and nested tables, said method comprising the steps of:
receiving a file comprising markup language statements and style sheets, said file describing the position of elements of content data in output to be provided by a remote output device;
retrieving and interpreting the position of elements of content data.

42. The method of claim 41 wherein said markup language is HTML and the style sheets are implemented using CSS.

43. A method for obtaining, at an output server, a description of position of elements of content data in output to be provided by a remote output device, said elements including text, graphics, images, and nested tables, said method comprising the steps of:
receiving a file comprising generalized markup language statements and style sheets, said file describing the position of elements of content data in output to be provided by a remote output device;
retrieving and interpreting the position of elements of content data.

44. The method of claim 43 wherein said generalized markup language is XML and the style sheets are implemented using CSS.
